(19) United States
(12) Patent Application Publication
(10) Pub. No.: US 2022/0242566 A1
(43) Pub. Date: Aug. 4, 2022

(54) CHASSIS STRUCTURES AND INTERCONNECTIONS FOR LIGHTER-THAN-AIR PLATFORMS

(71) Applicant: Loon LLC, Mountain View, CA (US)

(72) Inventors: Woodruff Phillips, Redwood City, CA (US); Carey Hijmans, Morgan Hill, CA (US)

(21) Appl. No.: 17/165,995

(22) Filed: Feb. 3, 2021

(51) Int. Cl. B64D 11/00; B64B 1/00

(52) U.S. Cl. CPC B64D 11/00; B64D 2011/0046; B64B 1/00

(57) ABSTRACT

Aspects of the technology relate to lighter-than-air (LTA) high altitude platforms configured to operate in the stratosphere. Such platforms can generate operate for weeks, months or longer. Shaped envelope LTA platforms may support a payload that provides telecommunications and/or other services to remote regions around the world. The payload may be arranged with other components on a modular bus-type chassis. One or more components may be moveable along the chassis to change the pitch of the vehicle for more effective flight operation. The modular chassis may include a truss configuration assembled from one or more subunits. The subunits may be preassembled with different equipment packages. Trusses formed using sets of struts may have two or more struts terminating at one interconnection node. Node connection elements, such as compound dovetail interconnects, facilitate a reliable, repeatable and quick mounting method for structural interconnections, which can lead to faster assembly and disassembly times.

### BACKGROUND

Telecommunications connectivity via the Internet, cellular data networks and other systems is available in many parts of the world. However, there are locations where such connectivity is unavailable, unreliable or subject to outages from natural disasters. Some systems may provide network access to remote locations or to locations with limited networking infrastructure via satellites or high altitude platforms. In the latter case, due to environmental conditions and other limitations, it is challenging to keep the platforms aloft and operational over a desired service area for long durations, such as weeks, months or longer. Such operation may require specialized platforms. However, customizing platforms prior to launch or modifying them after launch to meet operational goals can be extremely challenging or not possible with conventional architectures.

### SUMMARY

Aspects of the technology relate to a high altitude platform (HAP) that is able to remain on station or move in a particular direction toward a desired location, for instance to provide telecommunication services, video streaming or other services. The high altitude platform may be a lighter-than-air (LTA) platform such as a balloon, dirigible/airship or other LTA platform configured to operate in the stratosphere. For instance, the LTA platform may include an envelope filled with lift gas and a payload for providing telecommunication or video services, with a connection member coupling the payload with the envelope. The envelope may be a superpressure envelope, e.g., with a ballonet that can be used to aid in altitude control as part of an altitude control system (ACS). A lateral propulsion system may provide directional thrust for moving the LTA platform toward a destination or remaining on station over a location of interest (e.g., a city or regional service area). This can include a pointing mechanism that aligns a propeller assembly (or assemblies) of the lateral propulsion system such that the thrust moves the flight system along a desired heading.

The payload and lateral propulsion system may be arranged with other components on a modular bus-type chassis. In some instances, one or more components may be moveable along the chassis during flight, for instance to change the pitch of the vehicle for more effective flight operation, or otherwise improve aerodynamics and stability. The modular bus arrangement may include a truss-based chassis that can be assembled from one or more subunits. The subunits may be preassembled modules with different equipment packages that can be selected and assembled quickly on an as-needed basis. Trusses formed using sets of struts may have two or more struts terminating at the same interconnection node. Node connection elements, such as compound dovetail interconnects, can facilitate a reliable, repeatable and quick mounting method for structural interconnections, which can lead to faster assembly and disassembly times.

According to one aspect of the technology, a lighter-than-air (LTA) high altitude platform (HAP) is configured for operation in the stratosphere. The LTA HAP comprises an envelope, a modular chassis and a set of interconnection nodes. The envelope is configured to maintain pressurized lift gas therein for lighter-than-air operation in the stratosphere. The modular chassis is coupled to the envelope via a set of suspension lines. The modular chassis comprises a plurality of subunits, each subunit having a plurality of struts coupled together, at least one of the plurality of subunits having a set of photovoltaic (PV) components affixed thereto. The set of interconnection nodes is distributed along the modular chassis. One or more of the interconnection nodes of the set is configured to connect at least two struts together, and one or more of the interconnection nodes is configured to secure a first one of the plurality of subunits to a second one of the plurality of subunits.

In one example, at least one of the set of interconnection nodes comprises a compound dovetail connector. Here, the compound dovetail connector may secure a strut of the plurality of struts to one of the interconnection nodes of the set of interconnection nodes.

In another example, one or more subunits of the plurality of subunits is formed as trusses using at least some of the plurality of struts and one or more of the interconnection nodes of the set of interconnection nodes.

In a further example, the LTA HAP further comprises a pitch trim mechanism having a ballast component adjustably arranged therealong. The pitch trim mechanism may include one or more support tubes disposed between a chassis bulkhead panel on one end thereof and a lateral support member on an opposite end thereof. The ballast component may be configured to adjust a pitch of the LTA HAP by sliding along the one or more support tubes. The LTA HAP may further comprise an actuator assembly configured to move a position of the ballast component longitudinally along a given one of the plurality of subunits of the modular chassis.

In yet another example, the set of PV components comprises a set of solar panels affixed to the at least one of the plurality of subunits. In this case, the set of solar panels may be arranged along one or both sides of a truss structure of the at least one of the plurality of subunits.

In a further example, the LTA HAP further comprises a lateral propulsion system affixed to one of the plurality of subunits of the modular chassis. The lateral propulsion system may include one or more propeller assemblies affixed to the one of the plurality of subunits. In this case, the subunit having the one or more propeller assemblies affixed thereto may be a first subunit, and the at least one of the plurality of subunits having the set of PV components affixed thereto may be a second subunit different from the first subunit.

And in another example, the set of interconnection nodes distributed along the modular chassis includes a trio of nodes that are connected to a trio of the plurality of struts to form a chassis strut bulkhead.

According to another aspect of the technology, a lighter-than-air (LTA) high altitude platform (HAP) kit is provided. The kit comprises a plurality of chassis subunits each configured in a truss arrangement and a set of interconnection nodes. Each subunit has a plurality of struts coupled together. One or more of the interconnection nodes is configured to secure a first one of the plurality of chassis subunits to a second one of the plurality of chassis subunits. A first subset of the set of interconnection nodes is configured to secure the plurality of chassis subunits to a shaped envelope that is configured to maintain pressurized lift gas therein for lighter-than-air operation in the stratosphere.

In one example, a second subset of the set of interconnections includes a set of components configured for releasably coupling the plurality of chassis subunits to an assembly cart or a launch cart prior to launch of the LTA HAP into the stratosphere. In another example, at least one of the set of interconnection nodes comprises a compound dovetail connector.

According to a further aspect of the technology, a compound dovetail connector assembly is provided. The compound dovetail connector assembly comprises a tail element and a pin element releasably securable thereto. The tail element has a first end with a first dovetail connection member and a second end adapted to receive a first strut or other connector component of a high altitude platform (HAP) chassis. The first dovetail connection member has one or more through holes adapted to receive one or more fasteners. The pin element has a first end with a second dovetail connection member and a second end adapted to receive a second strut or other connector component of the HAP chassis. The second dovetail connection member has a mating geometry to the first dovetail connection member. The second dovetail connection member has one or more through holes adapted to receive the one or more fasteners to secure the pin element to the tail element.

In one example, the first dovetail connection member of the tail element has a geometry with a surface angled in a y− axis and a z− axis at the same time and mirrored to create a tail wedge along two axes; and the second dovetail connection member of the pin element has a complementary surface to the surface of the first dovetail connection member, which is angled in the y− axis and the z+ axis at the same time and mirrored to create a pin wedge along the two axes. Here, the pin and tail wedges along a first one of the two axes may be angled between 25° to 35°, and the pin and tail wedges along a second one of the two axes may be angled between 70° to 80°.

### BRIEF DESCRIPTION OF THE DRAWINGS

FIG. 1 is a functional diagram of an example system in accordance with aspects of the disclosure.

FIG. 2 illustrates an example lighter-than-air platform configuration in accordance with aspects of the disclosure.

FIGS. 3A-B illustrate example flight system modules including a payload, altitude control system and lateral propulsion system in accordance with aspects of the disclosure.

FIG. 4 illustrates an example of an airship platform in accordance with aspects of the disclosure.

FIG. 5 illustrates an example shaped envelope platform in accordance with aspects of the disclosure.

FIGS. 6A-B illustrate an example chassis configuration in accordance with aspects of the technology.

FIGS. 7A-C illustrate alternative chassis configurations in accordance with aspects of the disclosure.

FIGS. 8A-E illustrate modular chassis elements in accordance with aspects of the technology.

FIGS. 9A-D illustrate an example pitch trim assembly in accordance with aspects of the disclosure.

FIGS. 10A-C illustrate bulkhead and strut configurations, in accordance with aspects of the technology.

FIGS. 11A-H illustrates connector examples in accordance with aspects of the disclosure.

FIGS. 12A-B illustrate a compound dovetail connector example in accordance with aspects of the disclosure.

FIGS. 13A-E illustrate a first component of the compound dovetail connector of FIGS. 12A-B.

FIGS. 14A-E illustrate a second component of the compound dovetail connector of FIGS. 12A-B.

### DETAILED DESCRIPTION

### Overview

The technology relates to LTA high altitude platforms configured to operate in the stratosphere. Such platforms may provide telecommunications and other services from one or more communications modules that are part of the LTA vehicle's payload. This equipment, along with other payload devices (e.g., a control system, a power supply and a solar power generation module), is mounted along a modular bus-type chassis, for instance using truss-based submodules that allow for easy assembly and disassembly. An altitude control system and/or a lateral propulsion system can be coupled to the chassis either directly or via their placement along another part of the HAP (e.g., an air intake and venting assembly located along a base portion of a shaped envelope to effect altitude control).

Stratospheric HAPs, such as LTA platforms, may have a float altitude of between about 50,000-120,000 feet above sea level. The ambient temperature may be on the order of −10° C. to −90° C. or colder, depending on the altitude and weather conditions. These and other environmental factors in the stratosphere can be challenging for HAP operation, especially for long-duration deployment for months or longer. The architectures discussed herein are designed to effectively operate in such conditions, although they may also be used in other environments with different types of systems besides LTA-type platforms.

As explained below, an example HAP may include one or both of altitude control and/or a lateral propulsion system. Altitude control may be employed using an active altitude control system (ACS), such as with a pump and valve-type assembly coupled with an onboard ballonet. The lateral propulsion system may employ a propeller assembly to provide directional adjustments to the HAP, for instance to counteract movement due to the wind, or to otherwise cause the HAP to move along a selected heading. Such altitude and lateral adjustments can enhance operation across a fleet of HAPs. For instance, by employing a small amount of lateral propulsion and/or vertical adjustment at particular times, a given platform may stay on station over a desired service area for a longer period, or change direction to move towards a particular place of interest. The platform may also be able to return to the desired service area more quickly using lateral propulsion and/or altitude adjustments to compensate against undesired wind effects. Applying this approach for some or all of the platforms in the fleet may mean that the total number of platforms required to provide a given level of service (e.g., telecommunications coverage for a service area) may be significantly reduced as compared to a fleet that does not employ lateral propulsion.

The ACS may include a pump and valve arrangement as part of a vent and air intake assembly for a ballonet, which may be received within the shaped envelope. One or more motors can be used to actuate a lateral propulsion system of the HAP to affect the directional changes. This can include a pointing axis motor for rotating propellers to a particular heading, and a drive motor for causing a propeller assembly or other propulsion mechanism to turn on and off Powering the ACS, lateral propulsion system, communication system(s) and/or other modules of the HAP is done via an onboard power supply, such as one or more batteries that may be part of the payload assembly. The batteries may be charged using a solar power generation module, which includes solar panels or other photovoltaic (PV) components located, for example, along the chassis.

### Example Balloon Systems

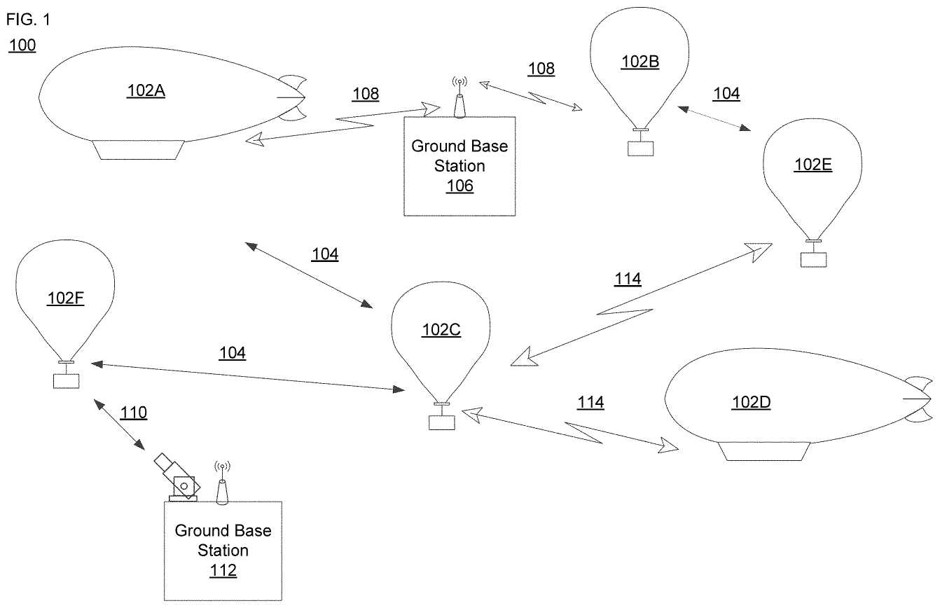

FIG. 1 depicts an example system 100 in which a fleet of high altitude platforms, such as LTA platforms, may be used. This example should not be considered as limiting the scope of the disclosure or usefulness of the features described herein. System 100 may be considered an LTA-based network. In this example, network 100 includes a plurality of devices, such as balloons or dirigibles 102A-F as well as ground-base stations 106 and 112. System 100 may also include a plurality of additional devices, such as various computing devices (not shown) as discussed in more detail below or other systems that may participate in the network.

The devices in system 100 are configured to communicate with one another. As an example, the HAPs may include communication links 104 and/or 114 in order to facilitate intra-balloon communications. By way of example, links 114 may employ radio frequency (RF) signals (e.g., millimeter wave transmissions) while links 104 employ free-space optical transmission. Alternatively, all links may be RF, optical, or a hybrid that employs both RF and optical transmission. In this way balloons 102A-F may collectively function as a mesh network for data communications. At least some of the HAPs may be configured for communications with ground-based stations 106 and 112 via respective links 108 and 110, which may be RF and/or optical links.

In one scenario, a given HAP 102 may be configured to transmit an optical signal via an optical link 104. Here, the given HAP 102 may use one or more high-power light-emitting diodes (LEDs) to transmit an optical signal. Alternatively, some or all of the HAP 102 may include laser systems for free-space optical communications over the optical links 104. Other types of free-space communication are possible. Further, in order to receive an optical signal from another HAP via an optical link 104, the HAP may include one or more optical receivers.

The HAPs may also utilize one or more of various RF air-interface protocols for communication with ground-based stations via respective communication links. For instance, some or all of the HAPs 102A-F may be configured to communicate with ground-based stations 106 and 112 via RF links 108 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

In some examples, the links may not provide a desired link capacity for HAP-to-ground communications. For instance, increased capacity may be desirable to provide backhaul links from a ground-based gateway. Accordingly, an example network may also include downlink HAPs, which could provide a high-capacity air-ground link between the various HAPs of the network and the ground-base stations. For example, in network 100, dirigible 102A or balloon 102B operating in the stratosphere may be configured as a downlink HAP that directly communicates with station 106.

Like other HAPs in network 100, downlink HAP 102F may be operable for communication (e.g., RF or optical) with one or more other HAPs via link(s) 104. Downlink HAP 102F may also be configured for free-space optical communication with ground-based station 112 via an optical link 110. Optical link 110 may therefore serve as a high-capacity link (as compared to an RF link 108) between the network 100 and the ground-based station 112. Downlink HAP 102F may additionally be operable for RF communication with ground-based stations 106. In other cases, downlink HAP 102F may only use an optical link for balloon-to-ground communications. Further, while the arrangement shown in FIG. 1 includes just one downlink HAP 102F, an example balloon network can also include multiple downlink HAPs. On the other hand, a HAP network can also be implemented without any downlink HAPs.

A downlink HAP may be equipped with a specialized, high bandwidth RF communication system for balloon-to-ground communications, instead of, or in addition to, a free-space optical communication system. The high bandwidth RF communication system may take the form of an ultra-wideband system, which may provide an RF link with substantially the same capacity as one of the optical links 104.

In a further example, some or all of HAPs 102A-F could be configured to establish a communication link with space-based satellites and/or other types of non-LTA craft (e.g., drones, airplanes, gliders, etc.) in addition to, or as an alternative to, a ground based communication link. In some embodiments, a stratospheric HAP may communicate with a satellite or other high altitude platform via an optical or RF link. However, other types of communication arrangements are possible.

As noted above, the HAPs 102A-F may collectively function as a mesh network. More specifically, since HAPs 102A-F may communicate with one another using free-space optical links, the HAPs may collectively function as a free-space optical mesh network. In a mesh-network configuration, each HAP may function as a node of the mesh network, which is operable to receive data directed to it and to route data to other HAPs. As such, data may be routed from a source HAP to a destination HAP by determining an appropriate sequence of links between the source HAP and the destination HAP.

The network topology may change as the HAPs move relative to one another and/or relative to the ground. Accordingly, the network 100 may apply a mesh protocol to update the state of the network as the topology of the network changes. For example, to address the mobility of the HAPs 102A to 102F, the balloon network 100 may employ and/or adapt various techniques that are employed in mobile ad hoc networks (MANETs). Other examples are possible as well.

Network 100 may also implement station-keeping functions using winds and altitude control and/or lateral propulsion to help provide a desired network topology, particularly for LTA platforms. For example, station-keeping may involve some or all of HAPs 102A-F maintaining and/or moving into a certain position relative to one or more other HAPs in the network (and possibly in a certain position relative to a ground-based station or service area). As part of this process, each HAP may implement station-keeping functions to determine its desired positioning within the desired topology, and if necessary, to determine how to move to and/or maintain the desired position. Alternatively, the platforms may be moved without regard to the position of their neighbors, for instance to enhance or otherwise adjust communication coverage at a particular geographic location.

The desired topology may thus vary depending upon the particular implementation and whether or not the HAPs are continuously moving. In some cases, HAPs may implement station-keeping to provide a substantially uniform topology where the HAPs function to position themselves at substantially the same distance (or within a certain range of distances) from adjacent balloons in the network 100. Alternatively, the network 100 may have a non-uniform topology where HAPs are distributed more or less densely in certain areas, for various reasons. As an example, to help meet the higher bandwidth demands, HAPs may be clustered more densely over areas with greater demand (such as urban areas) and less densely over areas with lesser demand (such as over large bodies of water). In addition, the topology of an example HAP network may be adaptable allowing HAPs to adjust their respective positioning in accordance with a change in the desired topology of the network.

The HAPs of FIG. 1 may be platforms that are deployed in the stratosphere. As an example, in a high altitude network, the LTA platforms may generally be configured to operate at stratospheric altitudes, e.g., between 50,000 ft and 70,000 ft or more or less, in order to limit the HAPs' exposure to high winds and interference with commercial airplane flights. In order for the HAPs to provide a reliable mesh network in the stratosphere, where winds may affect the locations of the various HAPs in an asymmetrical manner, the HAPs may be configured to move latitudinally and/or longitudinally by adjusting their respective altitudes, such that the wind carries the respective HAPs to the respectively desired locations. This may be done using an ACS. Lateral propulsion may also be employed, e.g., via one or more propellers, to affect the HAP's path of travel.

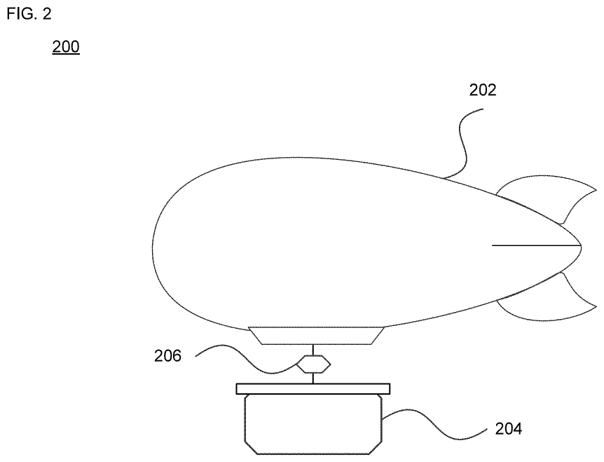

In an example configuration, the HAPs include an envelope and a payload, along with various other components. FIG. 2 is an example of a high-altitude airship 200, which may represent any of the LTA platforms of FIG. 1. As shown, the example airship 200 includes a shaped envelope 202, a flight system 204 containing a payload (e.g., telecommunication equipment) and other support systems and structures, and a termination (e.g., cut-down & parachute) device 206. The envelope 202 may take various shapes and forms. For instance, the envelope may be made of materials such as polyethylene, mylar, FEP, rubber, latex, fabrics or other thin film materials or composite laminates of those materials with fiber reinforcements embedded inside or outside. Other materials or combinations thereof or laminations may also be employed to deliver required strength, gas barrier, RF and thermal properties. Certain materials may be more suitable for smaller balloon-shaped envelopes, such as transparent or translucent thin films such as polyethylene or polyethylene terephthalate. However, larger shaped envelopes may employ one or more fabric layers, which may be less translucent.

Furthermore, the shape and size of the envelope may vary depending upon the particular implementation. Additionally, the envelope may be filled with different types of gases, such as air, helium and/or hydrogen. Other types of gases, and combinations thereof, are possible as well. In some examples, an outer envelope may be filled with lift gas(es), while an inner ballonet arrangement may be configured to have ambient air pumped into and out of it for altitude control. Other ballonet configurations are possible, for instance with the ballonet forming an outer envelope, while an inner envelope holds lift gas(es).

Envelope shapes for LTA platforms may include typical balloon shapes like spheres and “pumpkins” or aerodynamic shapes that are at least partly symmetric (e.g., teardrop-shaped, such as 202 in FIG. 2), provide shaped lift, or are changeable in shape. Lift may come from lift gasses (e.g., helium or hydrogen) with or without using a ballonet or other altitude control system, electrostatic charging of conductive surfaces, aerodynamic lift (wing shapes), air moving devices (propellers, flapping wings, electrostatic propulsion, etc.) or any hybrid combination of lifting techniques.

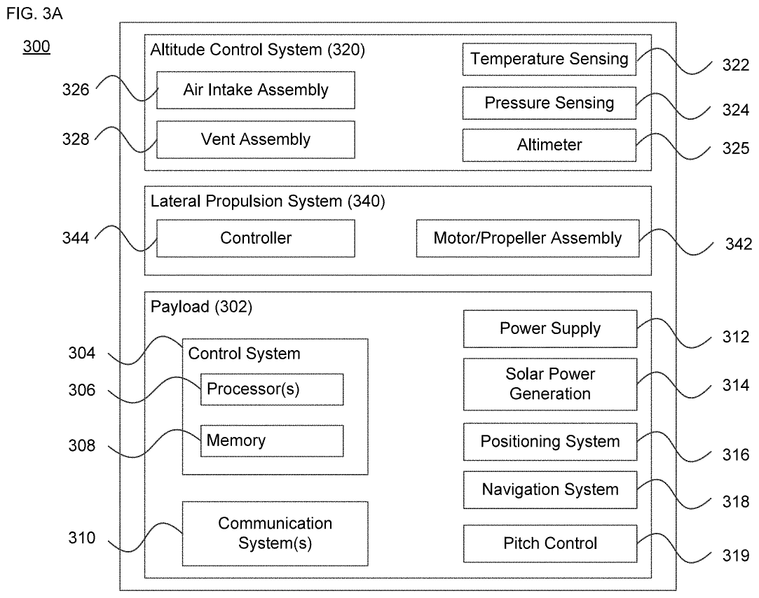

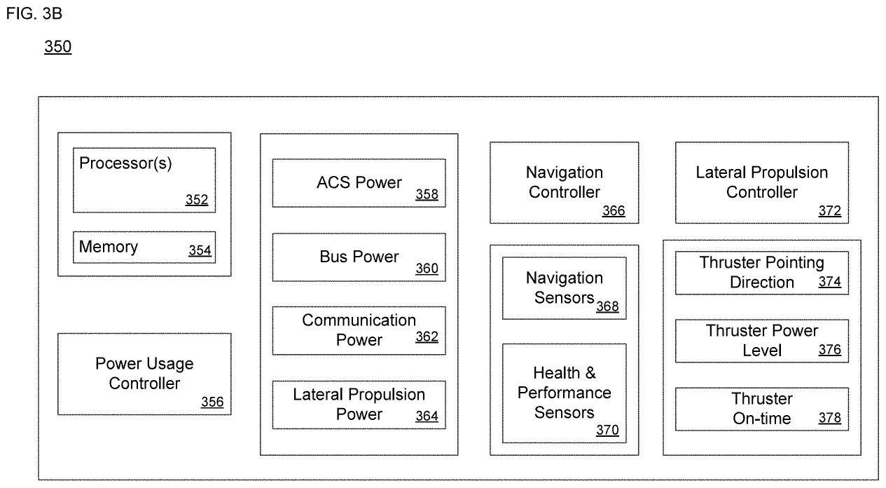

According to one example shown in FIG. 3A, a flight system 300 of an example HAP includes a payload 302, an altitude control system 320, and a lateral propulsion system 340. The payload 302 includes a control system 304 having one or more processors 306 and on-board data storage in the form of memory 308. Memory 308 stores information accessible by the processor(s) 306, including instructions that can be executed by the processors. The memory 308 also includes data that can be retrieved, manipulated or stored by the processor. The memory can be of any non-transitory type capable of storing information accessible by the processor, such as a hard-drive, memory card, ROM, RAM, and other memories. The instructions can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance.

The data can be retrieved, stored or modified by the one or more processors 306 in accordance with the instructions. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 306 can include any conventional processors, such as a commercially available CPU. Alternatively, each processor can be a dedicated component such as an ASIC, controller, or other hardware-based processor. Although FIG. 3A functionally illustrates the processor(s) 306, memory 308, and other elements of control system 304 as being within the same block, the system can actually comprise multiple processors, computers, computing devices, and/or memories that may or may not be stored within the same physical housing. For example, the memory can be a hard drive or other storage media located in a housing different from that of control system 304. Accordingly, references to a processor, computer, computing device, or memory will be understood to include references to a collection of processors, computers, computing devices, or memories that may or may not operate in parallel.

The payload 302 (or the flight system 300 generally) may also include various other types of equipment and systems to provide a number of different functions. For example, as shown the payload 302 includes one or more communication systems 310, which may transmit signals via RF and/or optical links as discussed above. The communication system(s) 310 include communication components such as one or more transmitters and receivers (or transceivers), one or more antennae, and a baseband processing subsystem. (not shown). In one scenario, a given communication module of the communication system operates in a directional manner. For instance, one or more high gain directional antennas may be mechanically or functionally pointed (e.g., via beamforming) in a selected direction(s) to enable uplink and/or downlink connectivity with other communications devices (e.g., other LTA platforms, ground stations, satellites in orbit or personal communication devices). In this case, it may be particularly beneficial to ensure that the given communication module is pointed at a target heading to ensure the communication link(s) (e.g., according to a determined communication bit error rate, signal-to-noise ratio, etc.).

The payload 302 is illustrated as also including a power supply 312 to supply power to the various components of the balloon. The power supply 312 could include one or more rechargeable batteries or other energy storage systems like capacitors or regenerative fuel cells. In addition, the payload 302 may include a power generation system 312 in addition to or as part of the power supply. The power generation system 314 may include solar panels or other PV components, stored energy (e.g., hot air relative to ambient air), relative wind power generation, or differential atmospheric charging (not shown), or any combination thereof, and could be used to generate power that charges and/or is distributed by the power supply 312. In some configurations, some of the PV components may be disposed along the payload or other portions of the flight system chassis while other PV components may be disposed along the envelope. In other configurations, the PV components may only be disposed along the envelope.

The payload 300 may additionally include a positioning system 316. The positioning system 316 could include, for example, a global positioning system (GPS) such as differential GPS (D-GPS), an inertial navigation system, and/or a star-tracking system. The positioning system 316 may additionally or alternatively include various motion sensors (e.g., accelerometers, magnetometers, gyroscopes, and/or compasses). The positioning system 316 may additionally or alternatively include one or more video and/or still cameras, and/or various sensors for capturing environmental data. Some or all of the components and systems within payload 302 may be implemented in a radiosonde or other probe, which may be operable to measure, e.g., pressure, altitude, geographical position (latitude and longitude), temperature, relative humidity, and/or wind speed and/or wind direction, among other information. Wind sensors may include different types of components like pitot tubes, hot wire or ultrasonic anemometers or similar, windmill or other aerodynamic pressure sensors, laser/lidar, or other methods of measuring relative velocities or distant winds.

Payload 302 may include a navigation system 318 separate from, or partially or fully incorporated into control system 304. The navigation system 318 may implement station-keeping functions to maintain position within and/or move to a position in accordance with a desired topology or other service requirement. In particular, the navigation system 318 may use wind data (e.g., from onboard and/or remote sensors) to determine altitudinal and/or lateral positional adjustments that result in the wind carrying the balloon in a desired direction and/or to a desired location. Lateral positional adjustments may also be handled directly by a lateral positioning system that is separate from the payload, which is discussed further below. Alternatively, the altitudinal and/or lateral adjustments may be computed by a central control location and transmitted by a ground based, air based, or satellite based system and communicated to the HAP. In other embodiments, specific HAPs may be configured to compute altitudinal and/or lateral adjustments for other HAPs and transmit the adjustment commands to those other HAPs. In some examples, part or all of the navigation system may be implemented by the lateral propulsion system 340.

In one configuration, one or more components of the flight system may be moveable along the chassis. A pitch control module 319 can be employed, for instance, to slide such components forward or aft (or side to side) along the chassis, to adjust the pitch of the HAP. The moveable components may include, by way of example only, batteries of the power supply, electronics modules, ballast, or other components which may be part of the flight system generally or of the payload. In another configuration, the entire flight system may be adjustable with respect to the lifting body of the envelope.

As illustrated in FIG. 3A, the flight system 300 also includes ACS 320 configured to carry out certain elevational positioning adjustments. The ACS may include sensors for temperature sensing 322 and/or pressure sensing 324, as well as an altimeter 325 to determine the HAP's altitude. It may also include an air intake assembly 326 and a vent assembly 328, for instance to respectively increase and decrease the amount of air within the ballonet. In one example, the air intake assembly may include a compressor or impeller to bring ambient air into the ballonet, and the vent assembly may include one or more valves to release the air from the ballonet to the external environment. While shown separately in this block diagram, the air intake and vent assemblies may be integrated as one unit.

In order to affect lateral positions or velocities, the platform includes lateral propulsion system 340. As shown in FIG. 3A, the lateral propulsion system 340 may include a motor and propeller assembly 342 and a controller 344. In this example, the motor is configured to turn or spin a propeller (or propellers) in order to increase or decrease the velocity of the aerial vehicle in a particular direction according to signals received from the controller 344. Changing the orientation of the propeller relative to the payload or other portions of the HAP may change the orientation and/or heading of HAP, similar to a rudder of a ship. In this regard, as compared to a typical balloon which does not utilize a propeller and simply relies on changes in ballast to move up and down and air currents to move in other directions, the LTA platform may have better steering control.

A block diagram of an exemplary electronics module 350 is illustrated in FIG. 3B. The electronics module may be part of or separate from the navigation system 318 or the control system 304 of the payload 302. As shown, a CPU, controller or other types of processor(s) 352, as well as memory 354, may be employed within the electronics module 350 to manage aspects of the lateral propulsion system and, alternatively or additionally, pitch control. A power usage controller 356 may be employed to manage various power subsystems of the electronics module, including for ACS power 358 (e.g., to control buoyancy of the envelope/vertical positioning of the LTA platform), bus power 360, communication power 362 and lateral propulsion power 364. The power usage controller 356 may be separate from or part of the processor(s) 352.

The control subsystem may include a navigation controller 366 that is configured to employ data obtained from onboard navigation sensors 368, including an inertial measurement unit (IMU) and/or differential GPS, received data (e.g., weather information), and/or other sensors such as health and performance sensors 370 (e.g., a force torque sensor) to manage operation of the LTA vehicle's systems. The navigation controller 366 may be separate from or part of the processor(s) 352, and may operate independently or in conjunction with navigation system 318. The navigation controller 366 works with system software, ground controller commands, and health & safety objectives of the system (e.g., battery power, temperature management, electrical activity, etc.) and helps decide courses of action. The decisions based on the sensors and software may be to save power, improve system safety (e.g., increase heater power to avoid systems from getting too cold during stratospheric operation) or divert power to altitude control or divert power to lateral propulsion.

When decisions are made to activate the lateral propulsion system, the navigation controller then leverages sensors for position, wind direction, altitude and power availability to properly point the propeller and to provide a specific thrust condition for a specific duration or until a specific condition is reached (a specific velocity or position is reached, while monitoring and reporting overall system health, temperature, vibration, and other performance parameters). In this way, the navigation controller can continually optimize the use of the lateral propulsion systems for performance, safety and system health. Upon termination of a flight, the navigation controller can engage the safety systems (for example a propeller braking mechanism) to prepare the system to descend, land, and be recovered safely. Similarly, the ACS may be controlled to start or increase airflow into a ballonet or to pump air out from the ballonet. This can include actuating a compressor, pump, impeller or other mechanism to effect the desired amount of airflow or otherwise adjust the vertical position of the HAP in the stratosphere.

Lateral propulsion controller 372 is configured to control the propeller's pointing direction (e.g., via a worm gear mechanism), manage speed of rotation, power levels, and determine when to turn on the propeller or off, and for how long. The lateral propulsion controller 372 thus oversees thruster pointing direction 374, thruster power level 376 and thruster on-time 378 modules. The lateral propulsion controller 372 may be separate from or part of the processor(s) 352. Processor software or received human controller decisions may set priorities on what power is available for lateral propulsion functions (e.g., using lateral propulsion power 364). The navigation controller then decides how much of that power to apply to the lateral propulsion motors and when (e.g., using thruster power level 376). In this way, power optimizations occur at the overall system level as well as at the lateral propulsion subsystem level. This optimization may occur in a datacenter on the ground or locally onboard the balloon platform.

The lateral propulsion controller 372 is able to control the drive motor of the propeller motor assembly so that the propeller assembly may operate in different modes. Two example operational modes are: constant power control or constant rotational velocity control. The electronics module may store data for both modes and the processor(s) of the control assembly may manage operation of the drive motor in accordance with such data. For instance, the processor(s) may use the stored data to calculate or control the amount of power or the rotational propeller velocity needed to achieve a given lateral speed. The electronics module may store data for the operational modes and the processor(s) of the control assembly may manage operation of the drive motor in accordance with such data. For instance, the processor(s) may use the stored data to calculate the amount of current needed to achieve a given lateral speed. The processor(s) may also correlate the amount of torque required to yield a particular speed in view of the altitude of the balloon platform. The processor(s) may control the drive motor continuously for a certain period of time, or may cycle the drive motor on and off for selected periods of time. This latter approach may be done for thermal regulation of the drive motor. For instance, the propeller may be actuated for anywhere from 1 second to 5 minutes (or more), and then turned off to allow for motor cooling. This may be dependent on the thermal mass available to dissipate heat from the motor. All of the components of the electronics module 350 and the overall flight system 300 may be powered by power supply 312, which is operatively coupled to the solar power generation module 314.

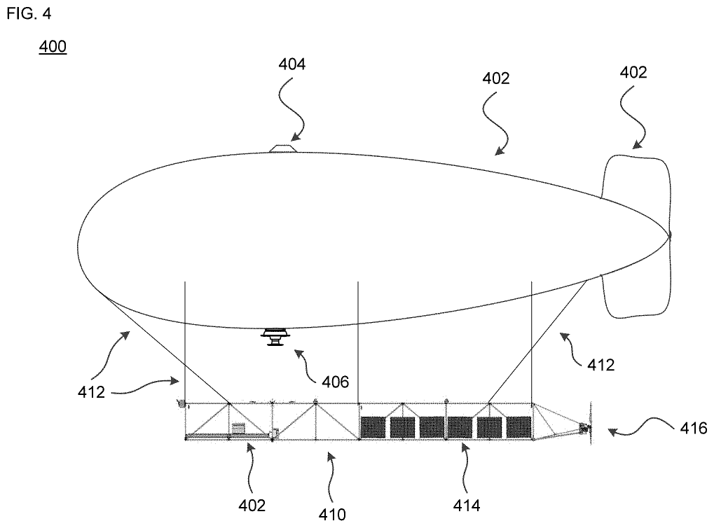

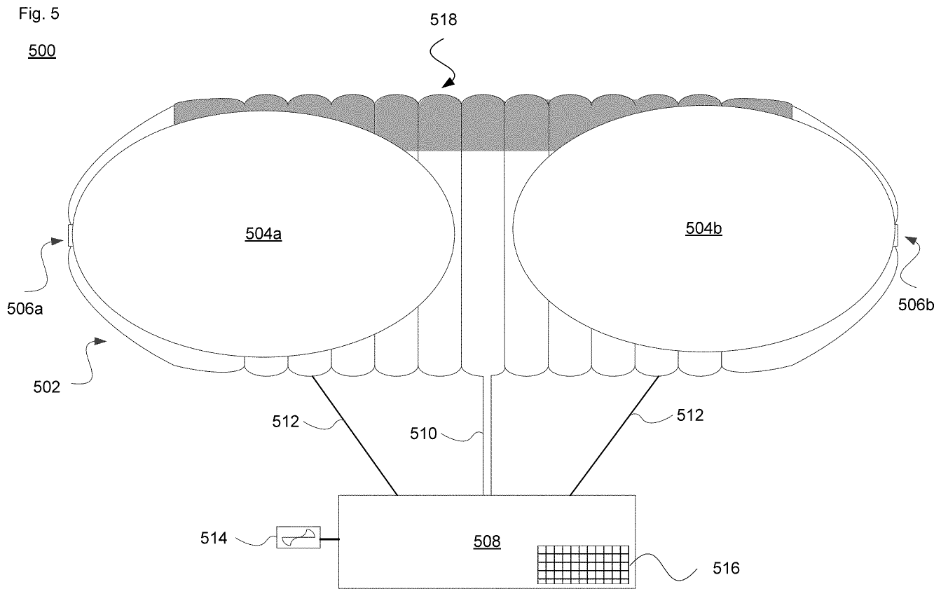

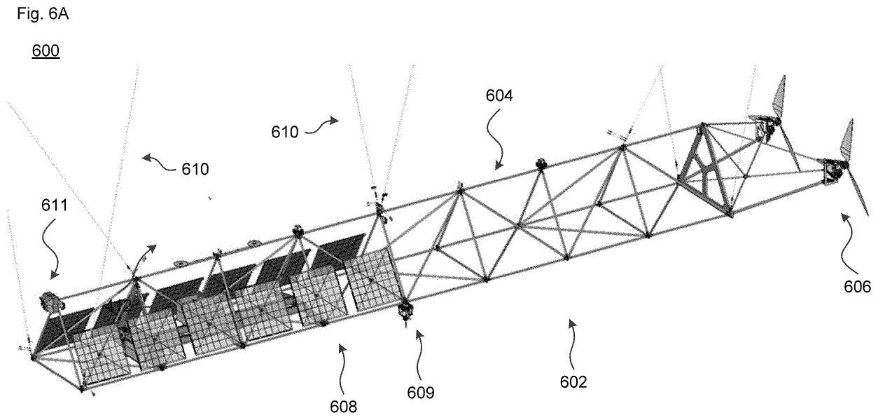

FIG. 4 illustrates one example configuration 400 of an airship-type HAP with propeller-based lateral propulsion, as well as an exemplary ACS, which may be employed with any of the LTA platforms of FIG. 1. As shown, the example 400 includes a shaped envelope 402 with a module 404 disposed along an upper region and a module 406 disposed along a lower region of the envelope. In one example, the upper module 404 may include navigation and/or environmental sensor components, such as a differential GPS, an inertial measurement unit, and/or sensors to detect ambient operating conditions such as pressure, humidity, the amount of charge in the air, etc. The module 406 may comprise ACS components coupled to an interior ballonet (see FIG. 5) disposed within the envelope 402. The ACS 406 is configured to draw ambient air into the ballonet and to expel air therefrom. One or more fins 408 may be affixed to the envelope. In one example, the fins 408 may be inflatable.

Modular chassis 410 including the payload is configured to couple the envelope 402 via suspension lines such as spars (or woven cables, ropes, struts, etc.) 412. One or more solar panel assemblies 414 may be coupled to the payload or another part of the chassis 410. Example 400 also illustrates a lateral propulsion system 416 using, for instance, one or more propeller assemblies. While the illustrated placement of the lateral propulsion system 416 is one possibility, the location could be either fore or aft of the payload on either the front or rear of the chassis 410. In other configurations, the lateral propulsion system may be affixed to one or more of the spars or other suspension lines 412, or to the envelope 402 itself.

FIG. 5 illustrates an example configuration 500 of a shaped envelope-type HAP with propeller-based lateral propulsion and altitude control using internal ballonets. As shown in the partial see-through view of FIG. 5, a pressurized envelope 502 has a pair of ballonets 504a and 504b received therein. In this example, ballonet 504a is arranged closer to end plate 506a which may be a forward end plate, and ballonet 504b is arranged closer to end plate 506b which may be a rearward end plate. Although not shown, additional ballonets may be arranged between and/or adjacent to ballonets 504a,b. Using multiple ballonets in such physical arrangements, with or without a barrier between them to constrain each ballonet in a desired location, may provide stability and reduce the likelihood of the envelope 502 from becoming pitched (upward or downward relative to the ground surface) too far in a particular direction.

Also shown in FIG. 5 is a chassis 508, which may be coupled to the envelope 502 via a downconnect element 510, as well as one or more spars, cables or other suspension lines 512. In this example, one or more propellers 514 of the lateral propulsion system may be connected to the chassis 508, although propellers may alternatively or additionally be connected to the downconnect element 510 and/or the envelope 502. Each of the one or more ballonets 504 may be connected to its own ACS module (not shown), for individualized inflation or deflation using separate air intake assemblies and vent assemblies.

### Example Arrangements

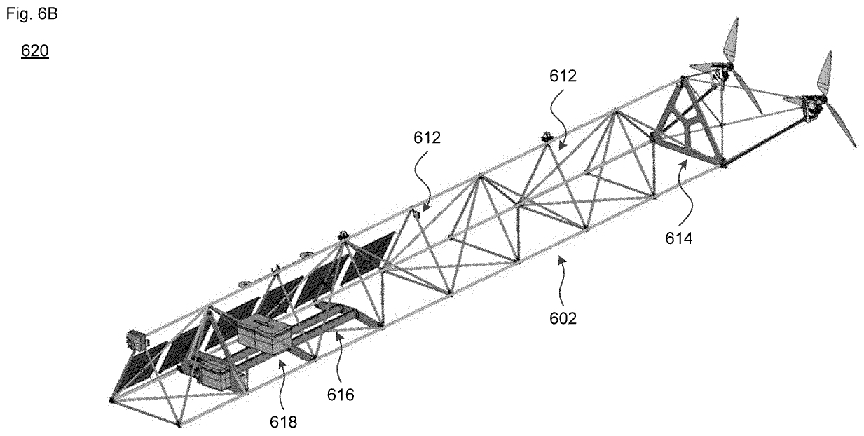

FIGS. 6A-B illustrate respective views 600 and 620 of an example chassis 602, similar to the chassis shown in FIG. 4. In this example, trusses formed of a series of struts 604 provide a platform for the payload and other equipment, including lateral propulsion system 606 disposed along one end of the chassis and a series of solar panels 608 disposed along an opposite end of the chassis. Suspension lines 610 are secured to different connection points (nodes) of the trusses. A small ballast component 609 may be directly affixed to one of the nodes. The ballast component 609 may include a tilt sensor. And a parachute module 611 may be affixed to one end of the chassis, for instance the end opposite the propellers of the lateral propulsion system.

View 620 omits the suspension lines and the solar panels on one side of the chassis. In this view, truss shapes can be seen, including triangular-shaped chassis strut bulkheads 612 and a chassis panel bulkhead 614. Also illustrated here is a pitch trim mechanism 616, with a ballast component 618, such as a battery module arranged therealong. These features are discussed in detail below.

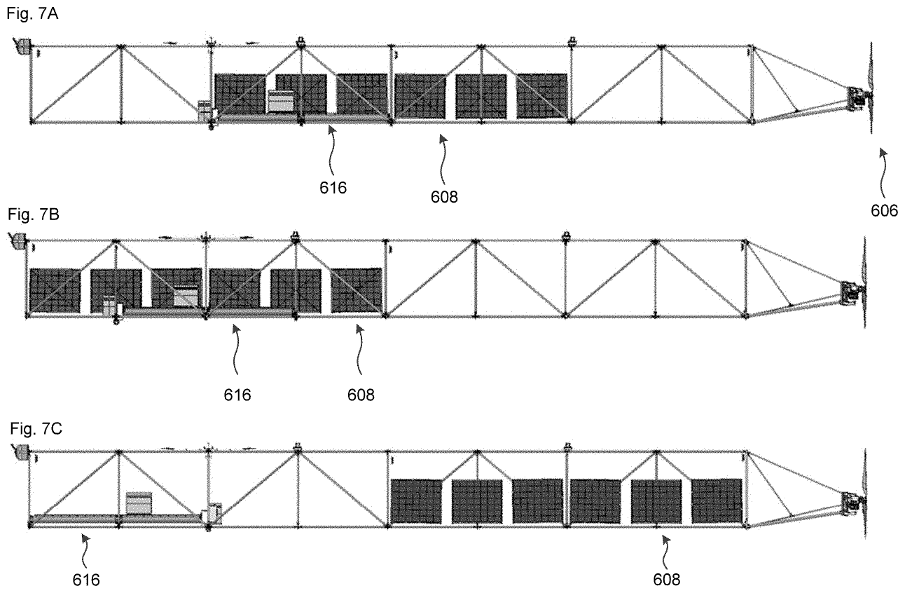

FIGS. 7A-C illustrate three variations for a fully assembled chassis, showing different placements for the solar panels 608 and the pitch trim mechanism 616 in relation to the propellers of the lateral propulsion assembly 606. For instance, as shown in FIG. 7A, the array of solar panels is centrally located relative to a first end of the chassis with the propellers and a second end opposite the first end. Here, the pitch trim mechanism may be positioned generally centrally, although somewhat closer to the second end of the chassis than the first end. For instance, the pitch trim mechanism may align with the three sets of solar panels closest to the second end. As shown in FIG. 7B, the array of solar panels is disposed along the second end of the chassis. Here, the pitch trim mechanism may be disposed in the middle of the array of solar panels. And as shown in FIG. 7C, the array of solar panels may be arranged on one end of the chassis while the pitch trim mechanism is arranged opposite the array. For instance, here the array of solar panels may be disposed adjacent to the first end of the chassis while the pitch trim mechanism is disposed adjacent to the second end of the chassis. These examples are non-limiting, and different configurations are possible. For instance, the solar panels may span the entire length of the chassis and/or the pitch trim mechanism may be disposed closer to the first end of the chassis or omitted entirely.

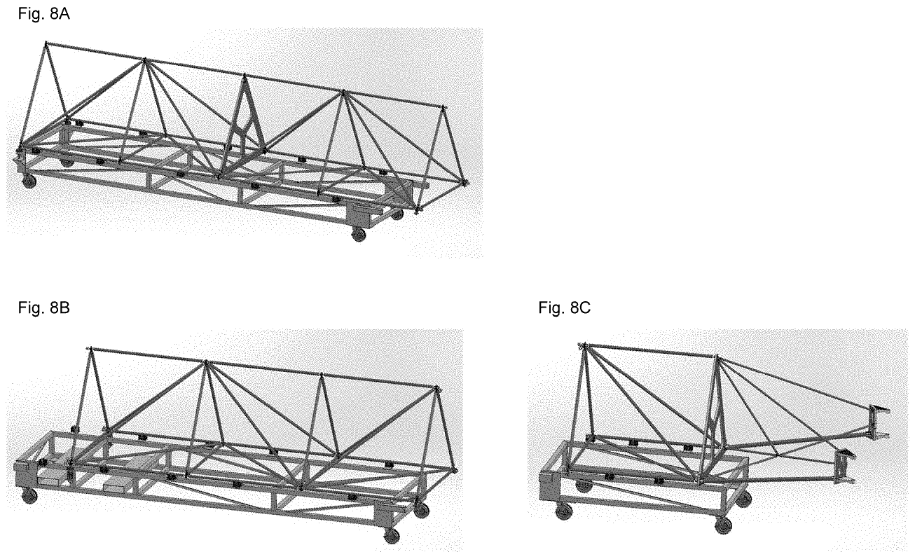

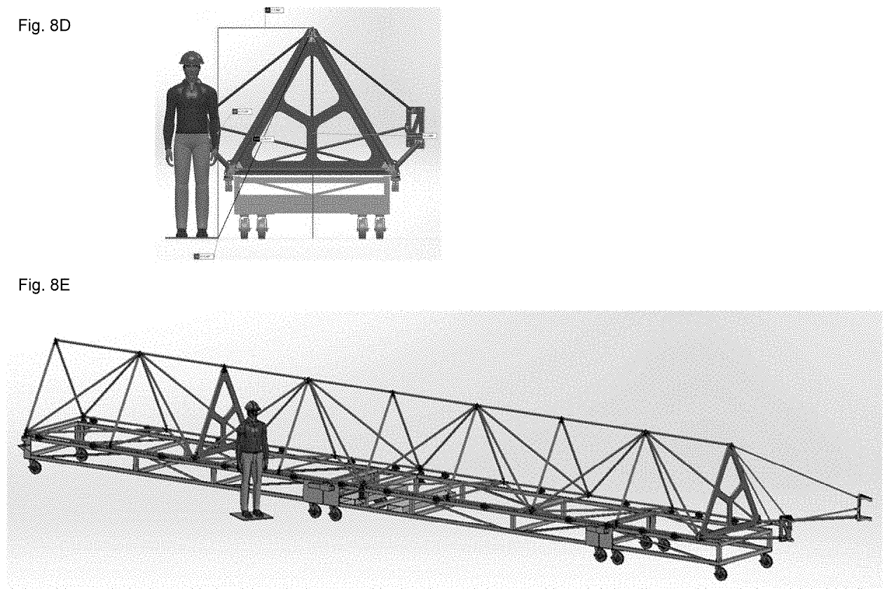

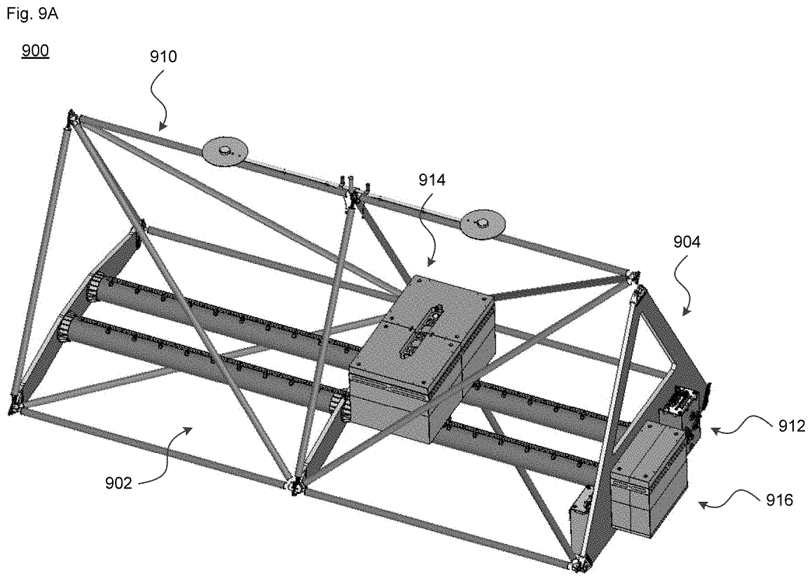

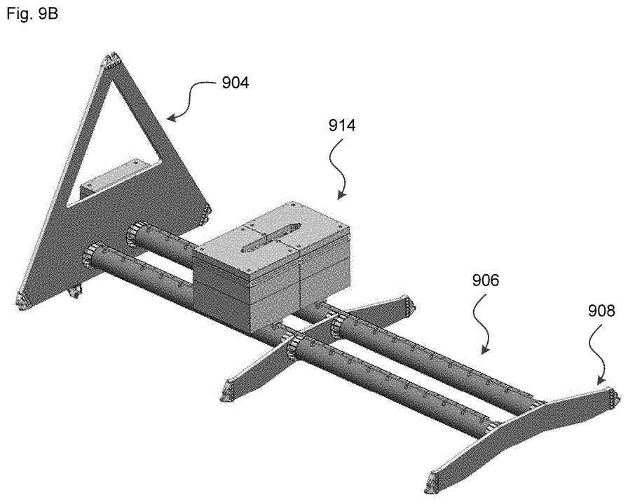

As noted above, the chassis may be modular, which permits rapid assembly and disassembly. FIGS. 8A-C illustrate examples of three respective sections of a HAP chassis, for instance with FIG. 8C having the first end of the chassis with brackets or other mounting components for the propeller assembly. In this scenario, FIG. 8A is the section along the second end of the chassis opposite the first end (when fully assembled). And FIG. 8B is the middle section disposed between the first and second end sections. As shown, each chassis section may be arranged on a wheeled cart, for easy maneuvering at the launch site or assembly facility. FIG. 8D illustrates a head-on view of the first section of FIG. 8C, showing a technician next to the wheeled cart. And FIG. 8E illustrates the assembled cart with all three sections from FIGS. 8A-C. In one example, the sections may be assembled before the payload, pitch trim mechanism, solar panels and/or lateral propulsion system are coupled to the chassis. Or, alternatively, some or all of these components may be mounted on the respective chassis sections, and then the sections can be secured to one another. While three chassis modules are shown, the system may include two, four or more modules, which can be selected and interchangeably connected based on the payload, flight duration, envelope type and/or other factors.

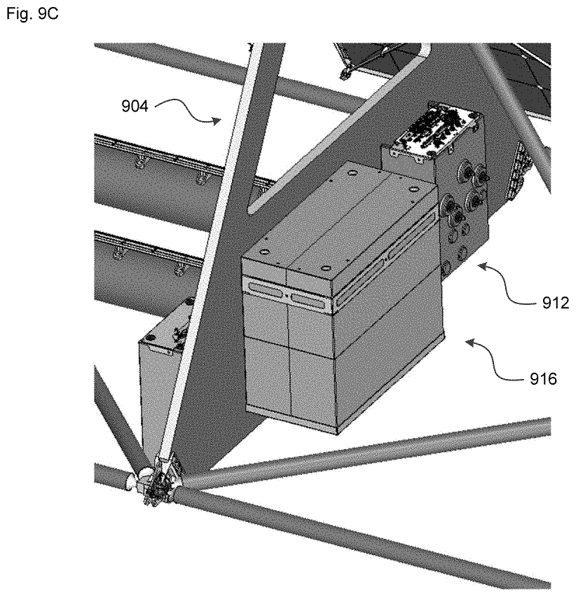

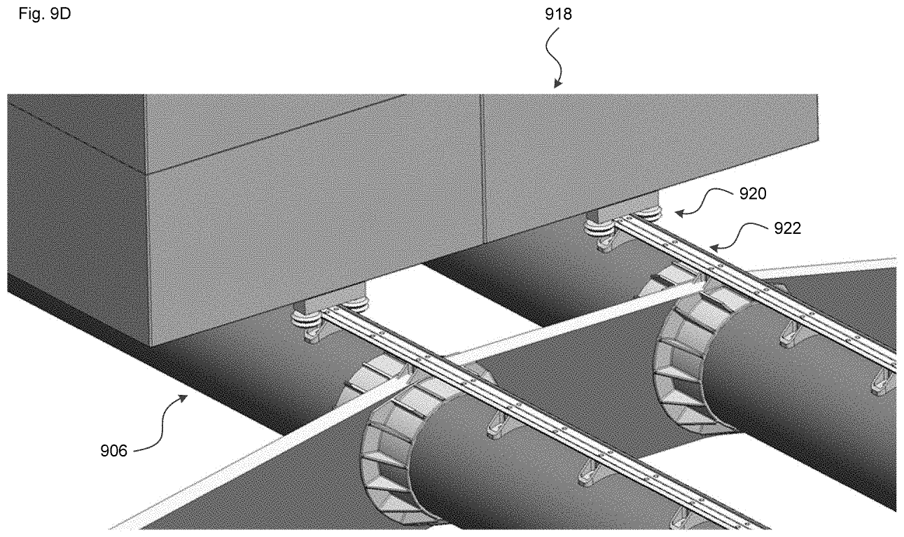

FIGS. 9A-D illustrate an example chassis module 900 having a pitch trim mechanism 902. As shown, a chassis panel bulkhead 904 is disposed on one end of the module. A pair of support tubes 906 spans the length of the module 900, coupling at one end to the bulkhead 904 and at the other end to a lateral support 908, which is affixed to the exterior truss structure 910. Another lateral support 908 is disposed centrally. While two support tubes 906 are shown, in an alternative configuration a single tube may be used. The tube(s) and/or the truss structure may be, e.g., carbon fiber, although other materials may be employed, such as aluminum.

As seen in the close-up perspective view of FIG. 9C, the side of the bulkhead 904 opposite the support tubes 906 is shown having an actuator assembly 912. The actuator assembly 912 may include, for instance, a worm gear motor or other mechanism to cause ballast 914 to travel along the support tubes 906 fore and aft. Module 916, which is affixed to the bulkhead 904, may be an avionics package. The avionics package may gather sensor data about current flight details, such as altitude, HAP pose (e.g., pitch, yaw and roll), speed, direction of travel, ambient air pressure, temperature and/or humidity, etc. And as seen in the close-up view of FIG. 9D, the ballast 918 sits on pairs of roller members 920 that are configured to move along tracks 922. The tracks 922 are mounted on the support tubes 906. The actuator assembly may be actuated by one or more processers, which may be part of the payload, lateral propulsion system, ACS or some other system of the HAP. For instance, information from the avionics package (e.g., current operating conditions including the pitch), a planned route, etc., may be used by the processor(s) to determine whether to move the ballast fore or aft in order to adjust the pitch of the shaped envelope or the HAP overall. The overall length and placement of the pitch trim mechanism may depend on the overall size of the chassis, or the size of a given chassis module. For instance, the tracks of the pitch trim mechanism may span the length of a chassis module, or less then the entire length. And as seen in the examples of FIG. 7A-C, the placement of the pitch trim mechanism along the overall chassis may vary.

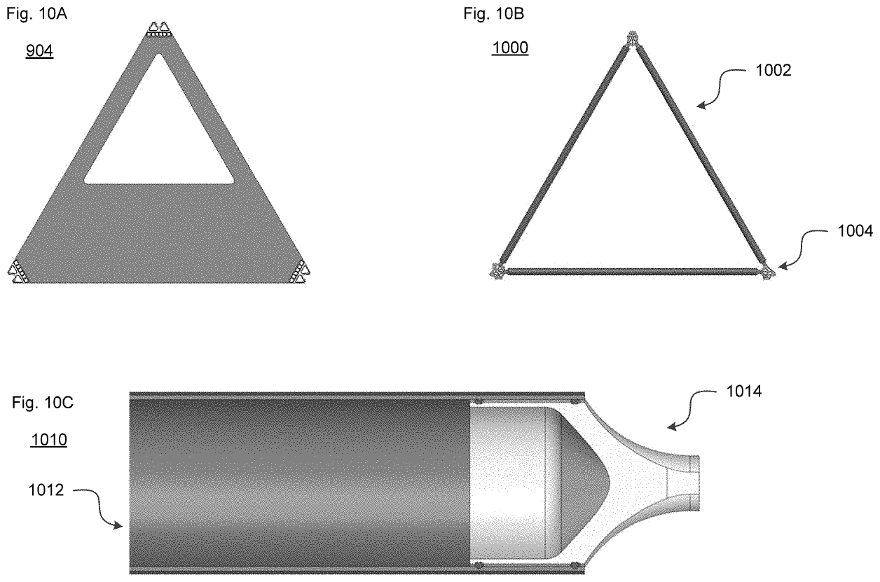

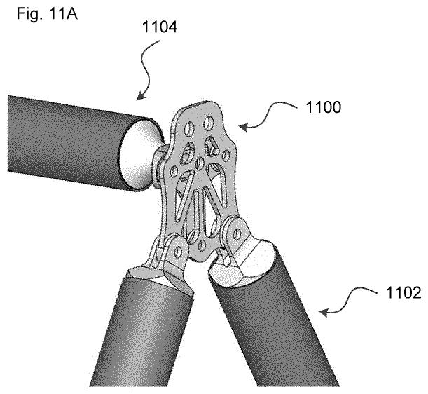

FIG. 10A illustrates a front view of the chassis panel bulkhead 904, while FIG. 10B illustrates a front view of a chassis strut bulkhead 1000. The chassis panel bulkhead 904 may be formed of a single sheet or one or more layers of material, such as a rigid plastic or metal (e.g., aluminum). The chassis strut bulkhead 1000 is formed, as shown in this example, of 3 equal length struts 1002, with ends that are coupled together by nodes 1004. Other struts of different lengths may coupled to the bulkhead 1000, for instance in a triangular truss-type arrangement. FIG. 10C illustrates a cross-sectional view 1010 of a strut end, which is shown with a cylindrical member 1012 affixed to an end 1014 configured to connect to node 1004.

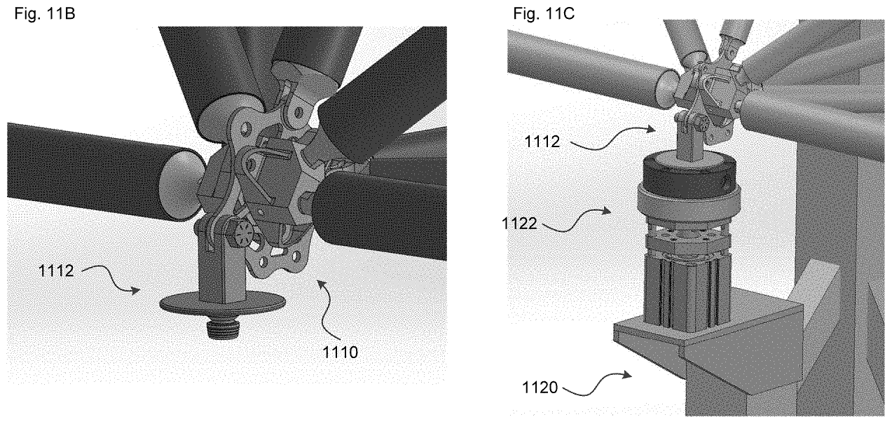

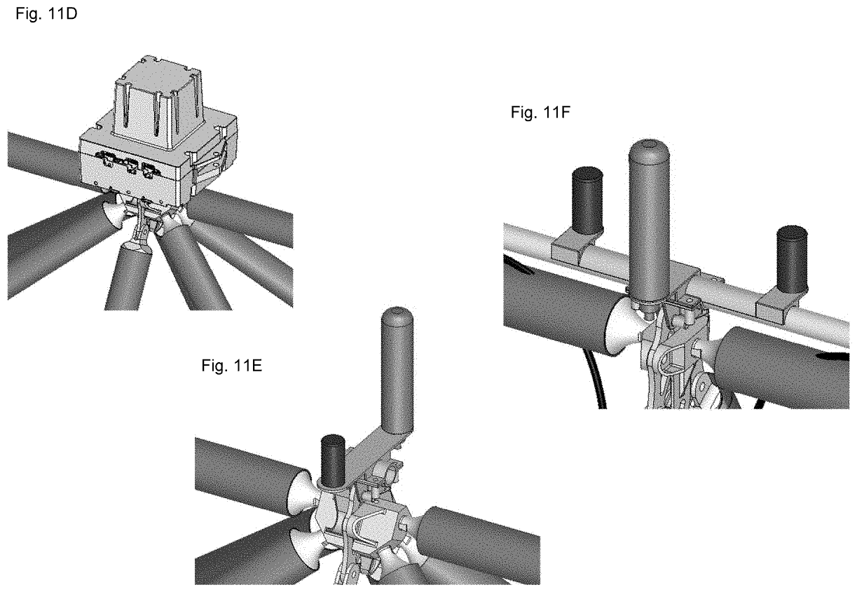

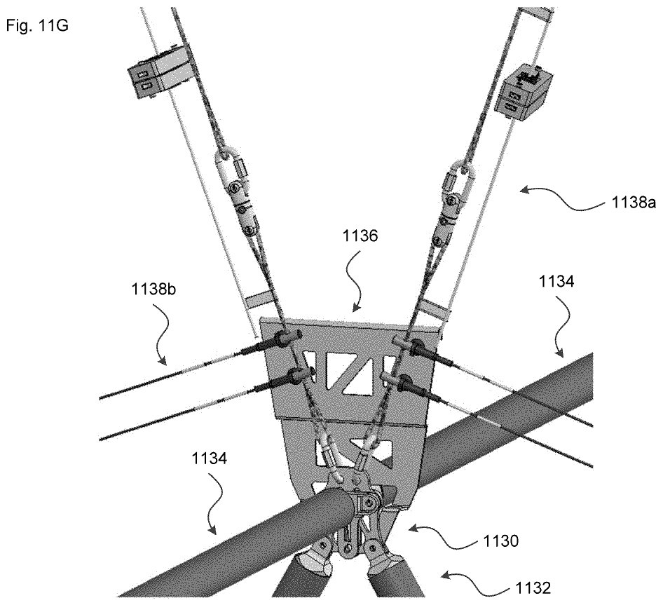

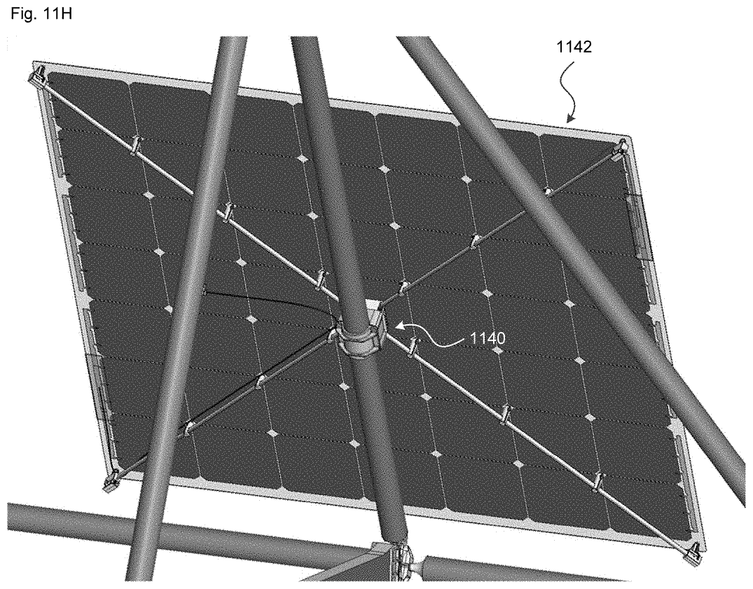

The interconnections at the nodes of the chassis can take on different forms, depending on how many struts, bulkheads, sensors and/or other devices are to be coupled together, their relative size, placement, angle, etc. For instance, FIG. 11A illustrates an example connector 1100 for a top node of the chassis, such as along a top part of a chassis strut bulkhead. As shown, two struts 1102 of the chassis strut bulkhead are affixed to lower corners of the connector 1100, using bolts or other coupling components. Another strut 1104 connects to a side face of the connector 1100 using a bolt or other fastener. As seen in this figure, the connector 1100 includes a number of through-holes or other receptacles to receive the struts (or other components).

FIG. 11B illustrates another example connector 1110, which may be disposed along a bottom portion of the chassis. Here, it can be seen than a number of struts are secured to the connector 1110 from different positions with varying angles. This can be done with a spherical-type joint with, e.g., a bolt and clevis type fastener arrangement. As shown, the assembly may also include a component 1112 for releasably coupling the chassis to an assembly cart or launch cart 1120 of FIG. 11C. By way of example, the cart 1120 may have a quick-release clamping module 1122 that engages with the component 1112, such as a single-acting clamping module from SCHUNK, e.g., the VERO-S NSE3 138. The component 1112 may be automatically released from the clamping module 1122 during a launch process. In one scenario, two or more components may secure the chassis to a launch cart, and be simultaneously released as the HAP is launched into the atmosphere.

FIGS. 11D-F illustrate examples of connectors at nodes along the chassis, which connect other devices in addition to the struts. For instance, these figures show communication equipment, such as antennas, transmission modules, beacons, sensors, etc., affixed to a top part of the connector, either directly or via a mounting platform that affixes to the connector. These arrangements permit the connector to provide structural integrity to the chassis by interconnecting the structs, while also efficiently mounting the communication equipment or other devices of the payload along the chassis. Providing mounting points for such devices at the nodes of the chassis enables the payload weight to be distributed along the chassis, which can avoid heavy load “hot spots”. It can also help avoid interference from signals of nearby antennas, since different antennas can be located at different places along the chassis.

FIGS. 11G-H illustrate additional connector examples. In particular, FIG. 11G illustrates an example bus line termination interface, in which a connector 1130 receives two angled struts 1132 from lower portions of the chassis, two linear struts 1134 in a coaxial arrangement, and a rigging plate 1136 affixed perpendicular to the linear struts 1134. The connector 1130 and the plate 1136 can be used to secure the shaped envelope of the HAP to the chassis via, e.g., suspension lines 1138a (see also suspension lines 412, 512 and 610 of FIGS. 4, 5 and 6A, respectively). suspension lines 1138b may be attached to the suspension lines 1138a on one end and to other portions of the chassis on the other end (not shown), for instance to prevent twisting or rotation of the envelope with respect to the chassis.

FIG. 11H illustrates a connector 1140, which is mounted along a middle section of a strut. This connector 1140 can be used to secure a solar panel 1142 to a chassis module. While only one connector 1140 is shown, multiple connectors can be used to prevent inadvertent movement of the solar panel relative to the chassis. And see also FIG. 9C for yet another example, in which a connector secures the chassis panel bulkhead 904 to struts from adjacent chassis modules.

Another connector configuration is shown in views 1200 of FIG. 12A and 1220 of FIG. 12B. In particular, views 1200 and 1220 illustrate a compound dovetail configuration for structural interconnections to facilitate a reliable, repeatable and quick mounting method. This approach enables the attachment and un-attachment of structural interconnections during normal assembly in all 6 degrees freedom, creating a solid reliable, repeatable, and quick to assemble structural joint interconnection with minimal tooling needed to assemble and disassemble. As a result, this will lead to faster assembly time and faster disassembly times. There are two main parts to the compound dovetail connector, the “tail” element 1202 and the “pin” element 1204, which may be connected together using one or both of a fastener 1206 (e.g., a screw or bolt) and a fastener 1208 (e.g., a clevis pin).

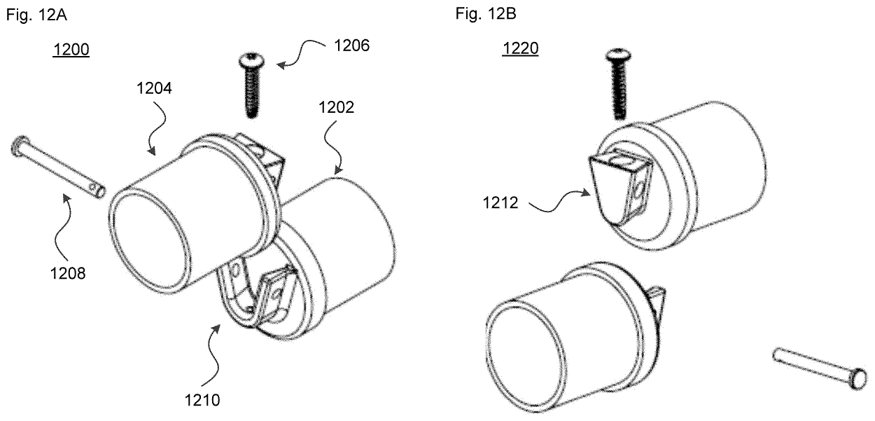

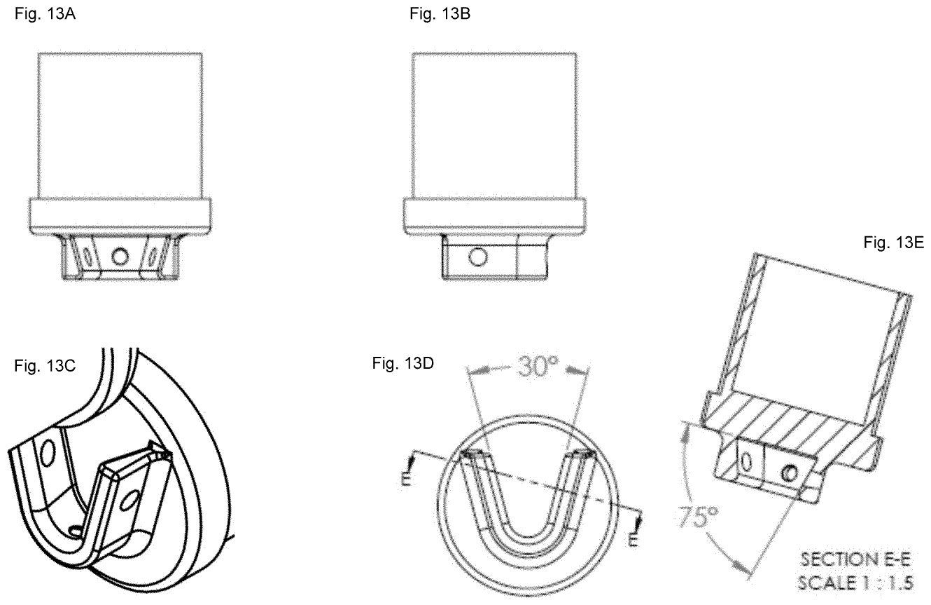

FIGS. 13A-E illustrate views of the tail element 1202. As seen in the top and side views of FIGS. 13A and 13B, respectively, the U- or V-shaped tail connector 1210 includes holes to receive either the fastener 1206 and/or the fastener 1208. The perspective view of FIG. 13C and the front view of FIG. 13D illustrate the tail connector 1210. In this scenario, the geometry of the compound dovetail of the connector 1210 has a surface angled in the y− axis and the z− axis at the same time and mirrored to create a wedge along two axes. As shown in this example, the angled sides of the tail have a 30° angle with a rounded base joining them together, although the angle may be more or less than 30° (e.g., on the order of 25° to 35°). FIG. 13E illustrates a cutaway view along the E-E line of FIG. 13D. As seen in the cutaway, the angle of the other wedge is at a 75° angle, although the angle may be more or less than 75° (e.g., on the order of 70° to 80°).

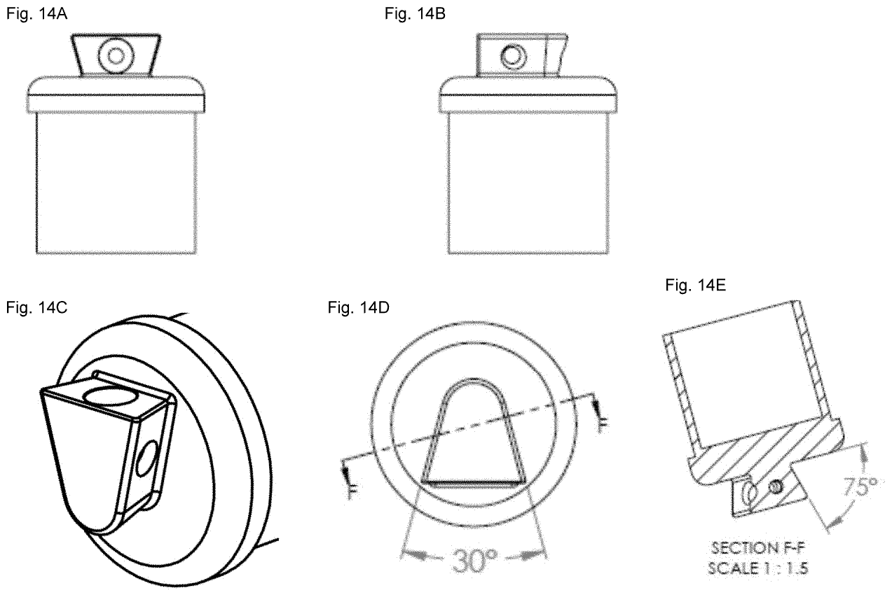

FIGS. 14A-E illustrate views of the pin element 1204. As seen in the top and side views of FIGS. 14A and 14B, respectively, the U- or V-shaped pin connector 1212 includes holes to receive either the fastener 1206 and/or the fastener 1208 (and which align with the respective holes in the tail connector 1210). The perspective view of FIG. 14C and the front view of FIG. 14D illustrate the pin connector 1212. In this scenario, the pin connector 1212 has the mating opposite geometry of the tail connector 1210, with a compound dovetail the has a surface angled in the y− axis and the z+ axis at the same time and mirrored to create a wedge along two axes. As shown in this example, the angled sides of the pin have the same 30° angle as the tail, although as noted above the angle may be more or less than 30° (e.g., on the order of 25° to 35°). FIG. 14E illustrates a cutaway view along the F-F line of FIG. 14D. Here, as in FIG. 13E, the angle of the other wedge is at a 75° angle, although the angle may be more or less than 75° (e.g., on the order of 70° to 80°).

The compound dovetail connector may be used with struts and other components to secure them at nodes along the chassis. For instance, the compound dovetail connector could have one side (e.g., the tail-side or the pin-side) affixed to an end of the strut (e.g., end 1014), while the complementary side (e.g., the pin-side or the tail-side) is part of a truss node (or another strut element, a solar panel, or other equipment).

The foregoing examples are not mutually exclusive and may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A lighter-than-air (LTA) high altitude platform (HAP) configured for operation in the stratosphere, comprising:
an envelope configured to maintain pressurized lift gas therein for lighter-than-air operation in the stratosphere;
a modular chassis coupled to the envelope via a set of suspension lines, the modular chassis comprising a plurality of subunits, each subunit having a plurality of struts coupled together, at least one of the plurality of subunits having a set of photovoltaic (PV) components affixed thereto; and
a set of interconnection nodes distributed along the modular chassis, one or more of the interconnection nodes of the set being configured to connect at least two struts together, and one or more of the interconnection nodes being configured to secure a first one of the plurality of subunits to a second one of the plurality of subunits.

2. The LTA HAP of claim 1, wherein at least one of the set of interconnection nodes comprises a compound dovetail connector.

3. The LTA HAP of claim 2, wherein the compound dovetail connector secures a strut of the plurality of struts to one of the interconnection nodes of the set of interconnection nodes.

4. The LTA HAP of claim 1, wherein one or more subunits of the plurality of subunits is formed as trusses using at least some of the plurality of struts and one or more of the interconnection nodes of the set of interconnection nodes.

5. The LTA HAP of claim 1, further comprising a pitch trim mechanism having a ballast component adjustably arranged therealong.

6. The LTA HAP of claim 5, wherein the pitch trim mechanism includes one or more support tubes disposed between a chassis bulkhead panel on one end thereof and a lateral support member on an opposite end thereof.

7. The LTA HAP of claim 6, wherein the ballast component is configured to adjust a pitch of the LTA HAP by sliding along the one or more support tubes.

8. The LTA HAP of claim 5, further comprising an actuator assembly configured to move a position of the ballast component longitudinally along a given one of the plurality of subunits of the modular chassis.

9. The LTA HAP of claim 1, wherein the set of PV components comprises a set of solar panels affixed to the at least one of the plurality of subunits.

10. The LTA HAP of claim 9, wherein the set of solar panels are arranged along one or both sides of a truss structure of the at least one of the plurality of subunits.

11. The LTA HAP of claim 1, further comprising a lateral propulsion system affixed to one of the plurality of subunits of the modular chassis.

12. The LTA HAP of claim 11, wherein the lateral propulsion system includes one or more propeller assemblies affixed to the one of the plurality of subunits.

13. The LTA HAP of claim 12, wherein the subunit having the one or more propeller assemblies affixed thereto is a first subunit, and the at least one of the plurality of subunits having the set of PV components affixed thereto is a second subunit different from the first subunit.

14. The LTA HAP of claim 1, where the set of interconnection nodes distributed along the modular chassis includes a trio of nodes that are connected to a trio of the plurality of struts to form a chassis strut bulkhead.

15. A lighter-than-air (LTA) high altitude platform (HAP) kit, the kit comprising:
a plurality of chassis subunits each configured in a truss arrangement, each subunit having a plurality of struts coupled together; and
a set of interconnection nodes, one or more of the interconnection nodes being configured to secure a first one of the plurality of chassis subunits to a second one of the plurality of chassis subunits;
wherein a first subset of the set of interconnection nodes is configured to secure the plurality of chassis subunits to a shaped envelope that is configured to maintain pressurized lift gas therein for lighter-than-air operation in the stratosphere.

16. The LTA HAP kit of claim 15, wherein a second subset of the set of interconnections includes a set of components configured for releasably coupling the plurality of chassis subunits to an assembly cart or a launch cart prior to launch of the LTA HAP into the stratosphere.

17. The LTA HAP kit of claim 15, wherein at least one of the set of interconnection nodes comprises a compound dovetail connector.

18. A compound dovetail connector assembly, comprising:
a tail element having a first end with a first dovetail connection member and a second end adapted to receive a first strut or other connector component of a high altitude platform (HAP) chassis, the first dovetail connection member having one or more through holes adapted to receive one or more fasteners; and
a pin element having a first end with a second dovetail connection member and a second end adapted to receive a second strut or other connector component of the HAP chassis, the second dovetail connection member having a mating geometry to the first dovetail connection member, the second dovetail connection member having one or more through holes adapted to receive the one or more fasteners to secure the pin element to the tail element.

19. The compound dovetail connector assembly of claim 18, wherein:
the first dovetail connection member of the tail element has a geometry with a surface angled in a y− axis and a z− axis at the same time and mirrored to create a tail wedge along two axes; and
the second dovetail connection member of the pin element has a complementary surface to the surface of the first dovetail connection member, which is angled in the y− axis and the z+ axis at the same time and mirrored to create a pin wedge along the two axes.

20. The compound dovetail connector assembly of claim 19, wherein the pin and tail wedges along a first one of the two axes are angled between 25° to 35°, and the pin and tail wedges along a second one of the two axes are angled between 70° to 80°.
